(19) United States
(12) Patent Application Publication
(10) Pub. No.: US 2005/0073985 A1
(43) Pub. Date: Apr. 7, 2005

(54) System and method for controlling a TTI in a W-CDMA communication system supporting enhanced uplink dedicated transport channel

(75) Inventors: Youn-Hyoung Heo, Suwon-si (KR); Ju-Ho Lee, Suwon-si (KR); Sung-Ho Choi, Suwon-si (KR); Young-Bum Kim, Seoul (KR); Yong-Jun Kwak, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/957,814

(22) Filed: Oct. 4, 2004

(30) Foreign Application Priority Data
Oct. 4, 2003 (KR) 2003-69045
Jul. 26, 2004 (KR) 2004-58452

(51) Int. Cl. H04B 7/216

(52) U.S. Cl. 370/342; 370/441

(57) ABSTRACT

A system and a method for enabling a node B to control a transmission time interval (TTI) in consideration of radio resources of a cell, a channel environment of a UE, and a buffer state of the UE, in an asynchronous wideband code division multiple access (W-CDMA) mobile communication system that supports a packet data service through an enhanced uplink dedicated transport channel.

### PRIORITY

This application claims priority to an application entitled “System And Method For Controlling TTI Change In WCDMA Communication System Supporting Enhanced Uplink Dedicated Transport Channel” filed in the Korean Intellectual Property Office on Oct. 4, 2003 and assigned Ser. No. 2003-69045, and filed Jul. 26, 2004 and assigned Ser. No. 2004-58452, the contents of both of which are incorporated herein by reference.

### BACKGROUND OF THE INVENTION

1. Field of the Invention

The present invention relates to a system and a method for enabling a node B to variably control a transmission time interval (TTI) in an asynchronous wideband code division multiple access (W-CDMA) mobile communication system that services enhanced uplink dedicated transport channels.

2. Description of the Related Art

In general, a data rate of an uplink channel is determined as a value not exceeding a predetermined maximum value of available data rates by a user equipment (UE), in which the maximum value of the data rate is provided to the UE by a radio network controller (RNC). That is, the data rates of conventional uplink channels are controlled without any connection to a node B.

However, in an enhanced uplink dedicated transport channel (EUDCH) scheme, a node B determines if uplink data is transmitted and the maximum value of the available data rate.

Such an EUDCH scheme has been proposed to further improve packet transmission in uplink communication in an asynchronous W-CDMA mobile communication system. Accordingly, in order to increase transmission efficiency, a number of studies have been made into using an adaptive modulation and coding (AMC) scheme, a hybrid automatic retransmission request (HARQ) scheme, a scheme using a short TTI, and a node B scheduling control scheme, which have been used in a conventional high speed downlink packet access (HSDPA) scheme, in the EUDCH scheme.

FIG. 1 is a view illustrating basic node B scheduling according to an EUDCH service in an asynchronous W-CDMA mobile communication system. Referring to FIG. 1, node B 110 is one of a set of active node Bs that support a data packet service through an EUDCH, and UEs 101, 102, 103, and 104 transmit packet data to the Node B 110 through the EUDCH. Reference numerals 111, 112, 113, and 114 represent EUDCH packet data transmitted from the UEs 101, 102, 103, and 104 according to data rates determined by node B scheduling, respectively.

In general, as the data rate used by a UE increases, a reception power of a node B resulting from a signal received from the UE increases. Conversely, as a data rate used by a UE decreases, a reception power of a node B UE becomes relatively lower. Accordingly, a signal transmitted from a UE using a relatively higher data rate exerts more influence on measurement ROT of the node B and a signal transmitted from a UE using a relatively lower data rate exerts less influence on measurement ROT of the node B. That is, as the data rate increases, more portions of measurement ROT (i.e., uplink radio resources) become occupied. In consideration of the relationship between a data rate and radio resources, and a data rate requested from a UE, the node B performs scheduling of EUDCH packet data.

More specifically, in order to improve the performance of the whole system, the node B may perform the scheduling to assign a low data rate to a far-side UE and to assign a high data rate to a near-side UE, while preventing a measurement ROT value from exceeding an object ROT value.

In FIG. 1, the distances from each of the UEs 101, 102, 103, and 104 to the node B 110 are different. That is, the UE 101 is located at the nearest position from the node B 110 and the UE 104 is located at the farthest position from the node B 110. The thickness of the arrows indicates the transmission powers used by the respective UEs 101, 102, 103, and 104. These transmission powers have different values depending on the distances between each UE and the node B 110. For example, the EUDCH transmission power of the UE 101, which is located at the nearest position from the node B 110, has the lowest transmission power value as illustrated by the thinnest arrow 111. Similarly, the EUDCH transmission power of the UE 104 located at the farthest position from the node B 110 has the highest value as illustrated by the thickest arrow 114.

Accordingly, the node B 110 may perform scheduling to cause the strength of the transmission power and a data rate to be inversely proportional to each other, such that the node B 110 can obtain the own best performance while maintaining an equal ROT and reducing inter-cell interference. That is, the node B 110 may perform scheduling to assign the highest data rate to the UE 101 that is located at the nearest position from the node B 110 and thus the uplink transmission power having the lowest value, and to assign the lowest data rate to the UE 104 that is located at the farthest position from the node B 110 and thus the uplink transmission power having the highest value.

FIG. 2 illustrates a signaling procedure for an enhanced uplink dedicated transport channel service between a node B and a UE in an asynchronous W-CDMA mobile communication system. In FIG. 2, reference numeral, 202 represents a UE to receive an EUDCH and reference numeral 201 is a node B to which the UE 202 belongs. In step 203, an EUDCH setup process for an EUDCH service is performed between the node B 201 and the UE 202. The EUDCH setup process includes steps of transmitting/receiving messages through a dedicated transport channel.

When the EUDCH setup process is completed, the UE 202 transmits information relating to a data rate and information relating to an uplink channel environment, which are necessary for scheduling, to the node B 201, in step 204. Such scheduling information may include information relating to the transmission power of the UE 202, which notifies the node B 201 of uplink channel information, information relating to the remaining power that the UE 202 can use for transmission, and information relating to the amount of packet data to be transmitted, which is stored in a buffer of the UE 202.

Therefore, when the node B 201 receives the scheduling information from a plurality of UEs, the node B 201 performs scheduling while monitoring the scheduling information in step 211. According to the scheduling in step 211, the node B 201 transmits scheduling assignment information to the UE 202 in step 205. That is, in step 205, the node B 201 determines and transmits the maximum data rate of a relevant UE that is provided with an EUDCH service (i.e., the maximum data rate of the UE 202 that can transmit actual packet data in a TTI), a modulation scheme to be used for the transmission of the data, and the number of assigned codes.

In step 212, the UE 202 selects an actual data rate of packet data to be transmitted through an EUDCH using the scheduling assignment information transmitted from the node B 201, i.e., using assigned data rate and timing information. In this case, the UE 202 selects a transport format resource indicator (TFRI) of the packet data to be transmitted through the EUDCH, which enables the node B 201 to prepare to receive the packet data to be transmitted from the UE 202.

In step 213, the node B 201 determines if TFRI information received in step 206 and/or packet data received through an EUDCH in step 207 are in error, and selects one of an acknowledgement (ACK) signal and a negative acknowledgement (NACK) signal, accordingly. Therefore, when any one of the TFRI information received in step 206 and the packet data received through an EUDCH in step 207 is in error, the node B 201 transmits a NACK signal to the UE 202, and if not, the node B 201 transmits an ACK signal to the UE 202 in step 208.

The basic procedure as described above is performed according to a predetermined TTI. In this case, change of the TTI causes change in the size of packet data capable of being transmitted for each TTI and in the entire exchange time period for an HARQ (Hybrid Automatic Retransmission Request).

FIG. 3 illustrates a relation between the TTI and the entire exchange time period for an HARQ. That is, FIG. 3 illustrates a case in which a UE transmits packet data through HARQ channel #1 301.

In FIG. 3, the channels indicate the maximum number of processing steps capable of simultaneously supporting the transmission of packet data and the reception of an ACK/NACK signal, which are performed in an HARQ processing step. Node B receives packet data transmitted from the UE after a predetermined propagation delay time Tₚᵣₒₚ 302 elapses. In this case, the node B receives the packet data for relevant T_{TTI} 303 and demodulates the received packet data. As a result of the demodulation, when there is no error, the node B transmits an ACK signal, and if there is an error, the node B transmits a NACK signal. A time period taken to process an ACK/NACK signal in the node B in step 304 corresponds to T_{NBP} 305, which changes depending on the size of packet data and the characteristics of a receiver.

An ACK/NACK signal transmitted from the node B arrives at the UE after a propagation delay time Tₚᵣₒₚ 306 elapses. The UE transmits new packet data for the next TTI 307 when receiving an ACK signal, but the UE retransmits previously transmitted packet data when receiving a NACK signal. Also, it takes T_{UEP} 308 to receive an ACK/NACK signal and to transmit new packet data or previously transmitted packet data.

A total time period taken to transmit one packet data may be calculated as shown in Equation (1).
Tₜₒₜₐₗ=Tₚᵣₒₚ+T_{TTI}+T_{NBP}+Tₚᵣₒₚ+T_{ACK/NACK}T_{UEP} (1)

In Equation (1), parameters T_{TTI} 303 and T_{ACK/NACK} 309 are influenced by the value of TTI. Therefore, when the TTI is lengthened, the values of the above two parameters increase, lengthening a data transmission time period, and causing a delay in packet transmission.

Recently, in order to determine an appropriate TTI for an EUDCH service, a short TTI of 2 ms used in the HSDPA scheme and a long TTI of 10 ms used in a conventional Rel 99 channel have been studied. When the long TTI is used, there is an advantage in that the construction of the conventional R99 DPDCH can be used, but with the disadvantage of a significantly longer delay than when using the short TTI. In contrast, when the short TTI is used, there is an advantage in that a delay shortens but there is the disadvantage in that a new physical layer channel and a signaling other than a TFCI, which is a prior indicator of a data format, are required due to the use of the shorter TTI than that of the prior DPDCH.

Also, the simplest method of using the short TTI adds a new code channel, which has the disadvantage of increasing a peak-to-average ratio. Hereinafter, examples of supporting an EUDCH according to each TTI will be described with reference to FIGS. 4A to 4C.

FIGS. 4A to 4C illustrate examples of supporting an EUDCH according to whether or not the short TTI and/or the long TTI is used. In FIGS. 4A to 4C, it is assumed that both UE A and UE B transmit 1,000-bit data. Also, it is assumed that the data of the UE A is data for supporting a background service to have a non-sensitive characteristic to delay and the data of the UE B is data for supporting a realtime video game to be sensitive to lag or data delay.

FIG. 4A illustrates a case in which both the UE A and the UE B perform scheduling by means of the long TTI of 10 ms 402. In FIG. 4A, because both the UE A and the UE B requests data transmission, a data rate 403 of the UE A and a data rate 404 of the UE B may be set to be an equal value within the TTI of 10 ms 402. Therefore, the UE A can be normally provided with an EUDCH service, but the UE B may not be provided with the real-time game due to increased delay.

FIG. 4B illustrates a case in which both the UE A and the UE B perform scheduling by means of the short TTI of 2 ms 408. When an environment in which the maximum allowed radio resources are limited, making it is impossible to identically schedule both the UE A and UE B, scheduling is performed to first assign radio resources 406 to the UE B because data corresponding to the UE B have a sensitive characteristic to delay, and to later assign radio resources 407 to the UE A.

In FIG. 4B, because the amount of the radio resources smaller than the maximum allowed radio resources of a cell are used for scheduling, radio resources of the cell remains and also the data of the UE A may be transmitted more rapidly than is necessary although the data of the UE A are insensitive to transmission delay. In order to improve the efficiency of the entire service according to use of an EUDCH service by efficiently using the advantage/disadvantage of the sort TTI and the long TTI as described above, scheduling can be performed variably using the long TTI and the short TTI as illustrated in FIG. 4C.

Referring to FIG. 4C, when scheduling is performed such that the UE B may use a short TTI as indicated by reference number 411 and the UE A may use a long TTI as indicated by reference number 412, it is possible to efficiently perform scheduling with the maximum allowed radio resources of a cell. That is, the UE B using the short TTI is first assigned radio resources and thus can normally be provided with a service without data delay. Also, the UE A using the long TTI can be further efficiently provided service in an environment of limited transmission power such as in a cell boundary. In the case of the UE A, when the node B simultaneously with a prior R99 node B supports a service to UE A, it is possible to further efficiently provide the service because the long TTI identical to that of the prior channel is used.

Although it is efficient to variably use the TTI as described above, a problem exists in that no detailed operations have been determined with respect to how to variably control the TTI.

### SUMMARY OF THE INVENTION

Accordingly, the present invention has been designed to solve the above-mentioned problems occurring in the prior art. More specifically, the present invention has been made to propose a system and a method for variably controlling the short TTI and the long TTI.

An object of the present invention is to provide a system and a method for variably controlling a TTI in an asynchronous wideband code division multiple access (W-CDMA) mobile communication system that services an enhanced uplink dedicated transport channel (EUDCH).

Another object of the present invention is to provide a system and a method for controlling a TTI and notifying a UE of the controlled information in an asynchronous W-CDMA mobile communication system that services an EUDCH.

Still another object of the present invention is to provide a system and a method for enabling a control scheduler of a node B to determine TTIs of data to be transmitted from a plurality of UEs in consideration of a radio resource condition of a cell, each state of buffers of the UEs, and a channel environment.

Yet another object of the present invention is to provide a system and a method for controlling a node B to notify a UE of a TTI and an assigned data rate through a control channel.

To accomplish the above and other objects, in accordance with one aspect of the present invention, there is provided a method for variably controlling a transmission time interval for packet data of a UE in a mobile communication system. The method includes the steps of: transmitting information relating to an amount of packet data to be transmitted through an uplink and information relating to a channel status of the UE from the UE to a node B; setting a transmission time interval for transmitting the packet data for each UE including the UE by the node B, in consideration of the information relating to the amount of the packet data transmitted through the uplink and the information relating to the channel status of the UE; and inserting the set transmission time interval into a downlink control channel and transmitting the downlink control channel according to the UEs.

In accordance with another aspect of the present invention, there is provided a method for controlling a transmission time interval by a node B in an asynchronous wideband code division multiple access (W-CDMA) mobile communication system which services an enhanced uplink dedicated transport channel. The method includes the steps of: transmitting information of representing a state of a buffer in which data to be transmitted through an uplink are stored and information of representing a channel status of a UE from the UE to the node B when the UE sets an uplink service; determining a transmission time interval and a transport format combination indicator of representing a radio resource to be assignable by the node B in consideration of the information of representing the state of the buffer and the information of representing the channel status; and transmitting the determined transport format combination indicator and transmission time interval to the UE through a control channel.

In accordance with still another aspect of the present invention, there is provided a method for variably controlling a transmission time interval for data packet of a UE by a node B in an asynchronous wideband code division multiple access (W-CDMA) mobile communication system that services an enhanced uplink dedicated transport channel. The method includes the steps of: determining a transmission time interval for the UE to transmit packet data through an uplink by the node B according to a set time period in consideration of a channel status of a cell in which the UE is located; transmitting packet data through an uplink data channel according to the determined transmission time interval by the UE; and transmitting information relating to a transmission time interval used in the UE from the UE to the node B through an uplink control channel.

In accordance with still another aspect of the present invention, there is provided a system for enabling a node B to variably control a transmission time interval for packet data of a UE in an asynchronous wideband code division multiple access (W-CDMA) mobile communication system that services an enhanced uplink dedicated transport channel. The system includes: a scheduling controller for receiving information relating to the amount of packet data to be transmitted through an uplink from a plurality of UEs, determining a maximum allowed transport format combination indicator and transmission time interval information for each of the UEs, and representing each determined indicator and each determined information in a bit unit; and an inserting unit for inserting specific error detection information for each UE into the maximum allowed transport format combination indicators and transmission time interval information, such that each UE can discriminates the maximum allowed transport format combination indicators and transmission time interval information.

In accordance with still another aspect of the present invention, there is provided a UE system for transmitting packet data to a node B in an asynchronous wideband code division multiple access (W-CDMA) mobile communication system that services an enhanced uplink dedicated transport channel. The system includes: a detector for receiving control information from the node B and performing an error detection operation using specific error detection information for the UE so as to check whether or not the control information is information for the UE; and an uplink controller for determining a transport format combination for packet data to be transmitted through an uplink, using the a maximum allowed transport format combination indicator and transmission time interval information transmitted from the detector.

### BRIEF DESCRIPTION OF THE DRAWINGS

The above and other objects, features, and advantages of the present invention will be more apparent from the following detailed description taken in conjunction with the accompanying drawings, in which:

FIG. 1 is a view illustrating a scheduling operation of a node B according to an enhanced uplink dedicated transport channel (EUDCH) service in an asynchronous wideband code division multiple access (W-CDMA) mobile communication system;

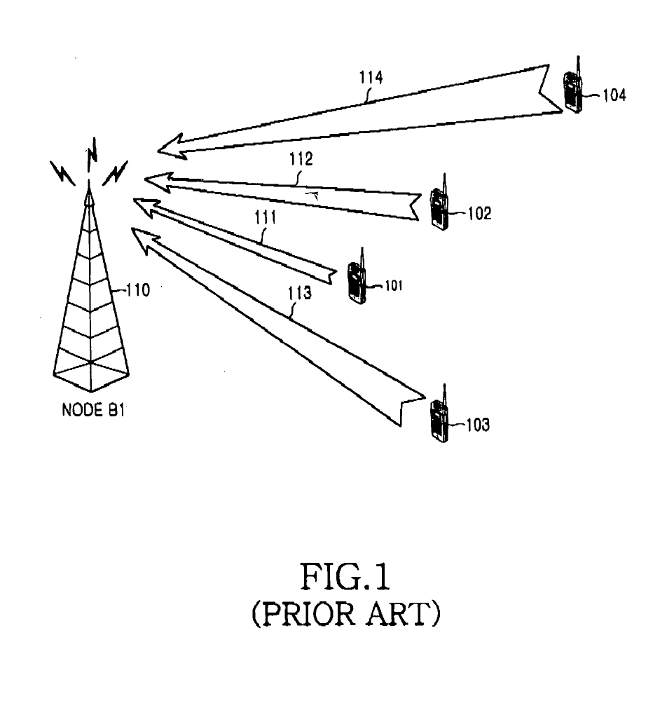

FIG. 2 is a view illustrating a signaling procedure between a node B and a UE for an EUDCH service in an asynchronous W-CDMA mobile communication system;

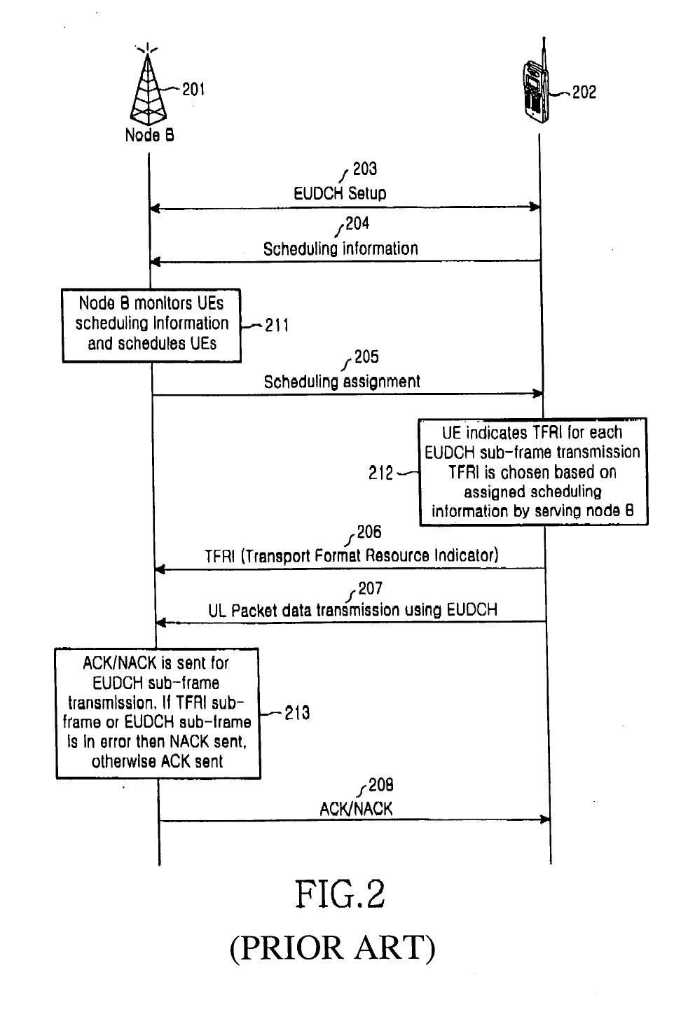

FIG. 3 is a time-flow diagram illustrating a transmission of packet data supporting a hybrid automatic retransmission request (H-ARQ) scheme;

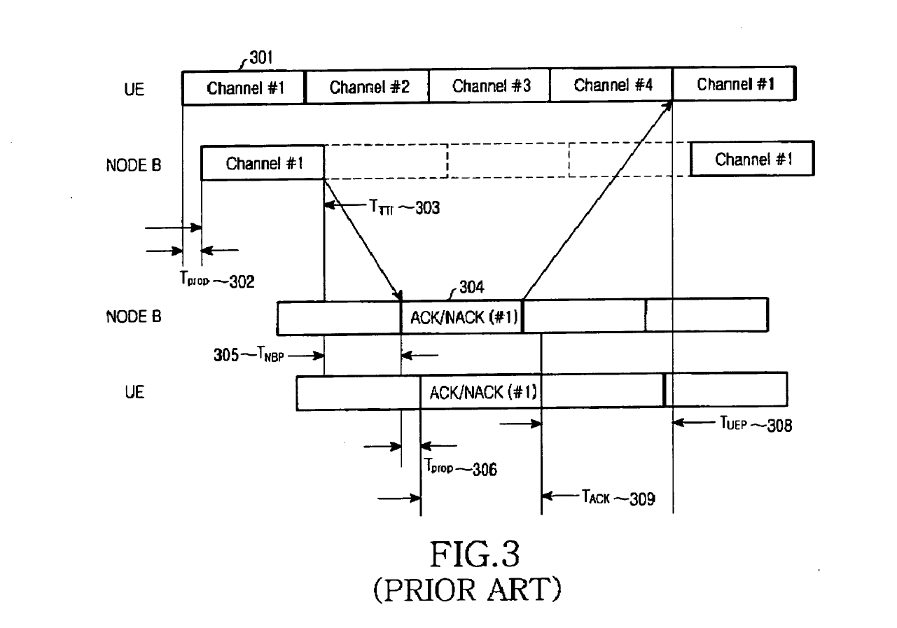

FIGS. 4A to 4C are views illustrating relations between a transmission time interval and scheduling of a node B;

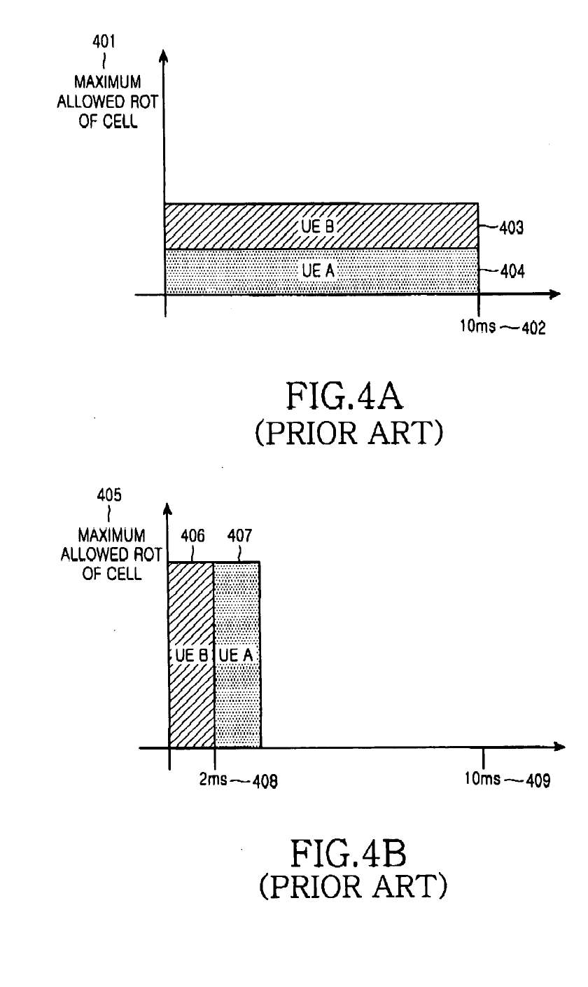

FIG. 5 is a view illustrating a channel structure according to an embodiment of the present invention;

FIG. 6A is a view illustrating signaling between a node B and a UE according to an embodiment of the present invention;

FIG. 6B is a view illustrating signaling between a node B and a UE according to another embodiment of the present invention;

FIG. 7 is a view illustrating a procedure of controlling a TTI when an EUDCH service is set according to an embodiment of the present invention;

FIG. 8 is a view illustrating a procedure of changing a TTI while an EUDCH service is being performed according to an embodiment of the present invention;

FIG. 9 is a view illustrating a construction of a scheduling controller in a node B according to an embodiment of the present invention;

FIG. 10 is a block diagram illustrating a transmitter of a node B according to an embodiment of the present invention;

FIG. 11 is a block diagram illustrating a UE according to an embodiment of the present invention;

FIG. 12 is a view illustrating a structure of a frame transmitted with flag information and an E-TFCI separated from each other according to an embodiment of the present invention;

FIG. 13 is a view illustrating a structure of a frame transmitted with flag information and an E-TFCI simultaneously processed according to an embodiment of the present invention;

FIG. 14 is a block diagram illustrating an E-DPCCH generator when flag information and an E-TFCI are separately transmitted according to an embodiment of the present invention; and

FIG. 15 is a block diagram illustrating an E-DPCCH generator when flag information and an E-TFCI are simultaneously processed and transmitted according to an embodiment of the present invention.

### DETAILED DESCRIPTION OF THE PREFERRED EMBODIMENT

Preferred embodiments of the present invention will be described in detail herein below with reference to the accompanying drawings. In the following detailed description, representative embodiments of the present invention will be described to realize the above-mentioned purposes. In addition, a detailed description of known functions and configurations incorporated herein will be omitted when it may obscure the subject matter of the present invention.

The present invention proposes a system and a method for enabling a node B to determine a TTI to variably control the TTI in an environment for supporting an EUDCH service using a node B control scheduling mechanism and for enabling the node B to notify a relevant UE of the determined TTI.

A method of determining a TTI in the node B is performed as follows.

First, the node B receives an ROT level of a cell, a channel environment of each UE, and a buffer state of each UE for a control scheduling.

Second, the node B simultaneously determines both a TTI and a data rate that can be used by each UE. In this case, it is possible to change an algorithm for determining the data rate and the TTI depending on a scheduling algorithm of each node B.

Third, the node B transmits information relating to the determined data rate and TTI to each relevant UE through a control channel.

A method of receiving a TTI determined by the node B in a UE is performed as follows.

First, the UE monitors a control channel and demodulates data rate and TTI information included in the control channel.

Second, the UE determines a size of EUDCH data to be transmitted using the data rate and TTI determined by the node B.

Third, the UE transmits EUDCH packet data in the determined data size within a predetermined TTI.

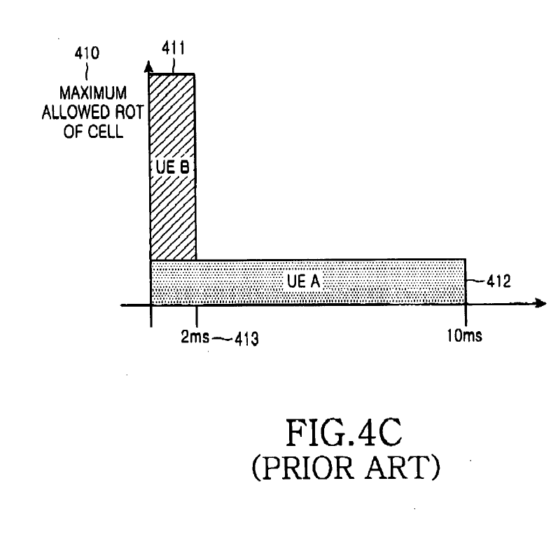

FIG. 5 is a view illustrating a channel structure according to an embodiment of the present invention. Referring to FIG. 5, when a buffer of a UE has packet data to be transmitted through an EUDCH, the UE transmits information required for scheduling of a node B to the node B as indicated by reference numeral 504 for the purpose of being assigned radio resources, which is necessary for the transmission of the EUDCH data, from the node B. For example, the UE transmits information relating to a buffer state of the UE and channel status information (CSI) for notifying the node B of a radio channel environment in which the UE is located. In this case, the buffer state and the CSI are transmitted through a reverse request channel (R-REQCH) 503 at step 505. Therefore, the node B performs scheduling using the buffer state and the CSI, and transmits maximum allowed transport format combination (TFC) and TTI 501, which are determined according to the scheduling, to the UE through an EU-SCCH 502 at step 506.

When the UE receives the TFC and TTI determined by the node B, the UE recognizes these information and then transmits packet data through an E-DCH on the basis of the assigned TFC and TTI. The E-DCH includes an EU-DPDCH 507 to transmit packet data, which the UE desires to transmit, and an EU-DPCCH 508 to include control information for demodulating packet data transmitted through the EU-DPDCH. Through the EU-DPCCH 508, a transport format and resource indicator (E-TFRI) for demodulating an EUDCH service transmitted through the EU-DPDCH 507 is transmitted. In addition, through the EU-DPCCH 508, a redundancy version (RV) and a new data indicator (NDI) for supporting H-ARQ may be transmitted, and also a quality of service (QoS) and the like may additionally be transmitted. The QoS causes an initial power to be set to a high value when a delay requirement of a transmitted E-DCH has a high value.

The EU-DPDCH is a dedicated physical data channel for the EUDCH service and is used to transmit packet data using a data rate that is determined according to scheduling information received from the node B. In this case, a channel to transmit actual packet data can use a short TTI and/or a long TTI according to the setup of a node B. In embodiments of the present invention, 2 ms is used as a short TTI and 10 ms is used as a long TTI.

When a UE transmits packet data in a short TTI of 2 ms according to the scheduling of the node B, the EU-DPDCH 507 is assigned a new code channel and transmits the packet data through code multiplexing with another uplink channel. In this case, the EU-DPDCH 507 transmits a conventional transport format combination indicator (TFCI) and an E-TFCI 510 for an EUDCH, while differentiating the two indicators from each other.

When EUDCH data is transmitted in a TTI of 10 ms, the EUDCH data may be transmitted through code multiplexing, as in the case of the TTI of 2 ms, or may be transmitted through transport channel multiplexing with a conventional Rel99 channel, which does not requires a separate E-TFCI.

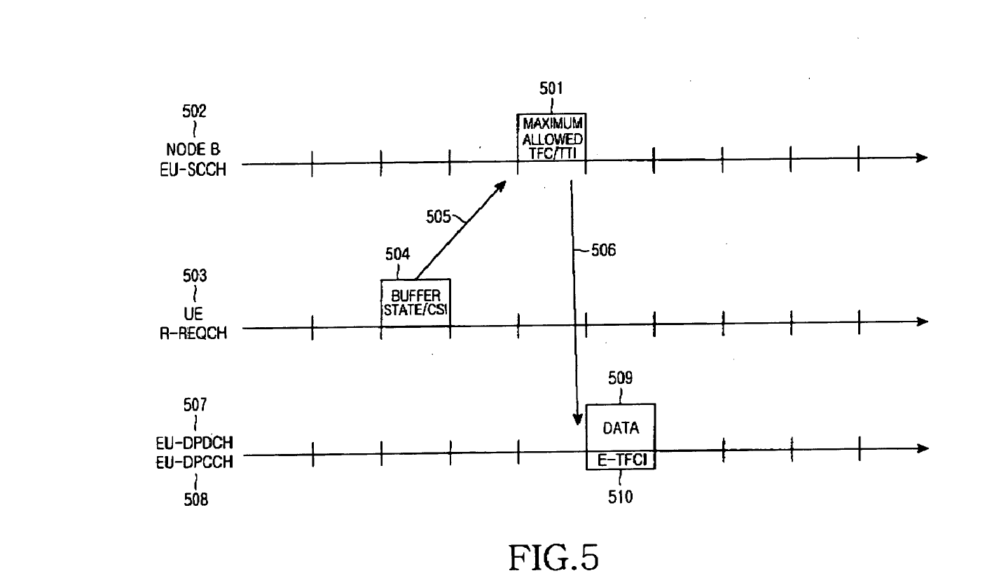

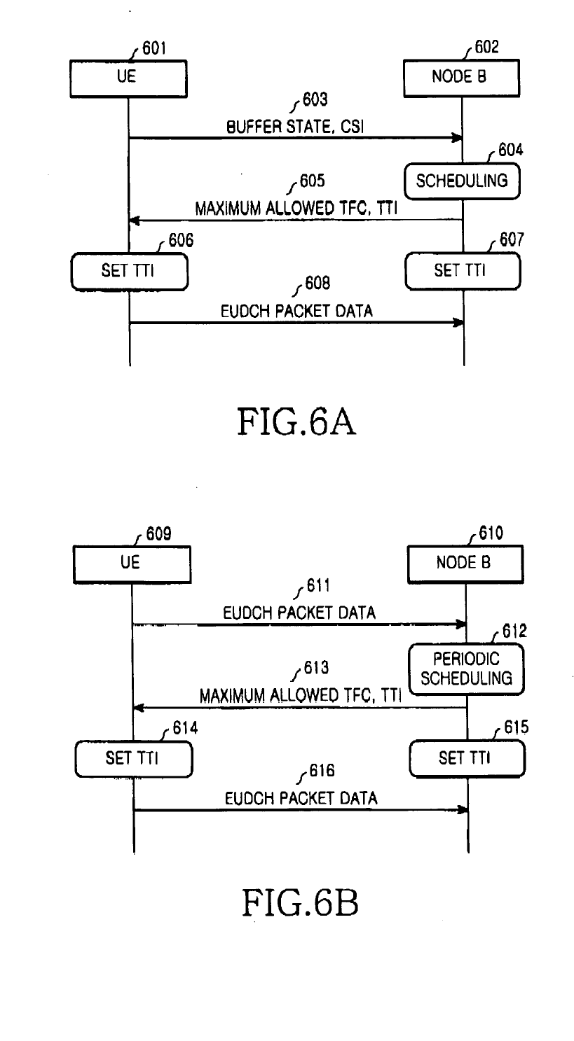

FIG. 6A is a view illustrating a procedure for determining a TTI by a node B using CSI and a buffer state of a UE when a service is set according to an embodiment of the present invention. In step 603, when a UE 601 sets an EUDCH service with a node B 602, for example, when packet data to be transmitted through the EUDCH service are transported to a buffer of the UE 601, the UE 601 requests radio resource assignment to the node B 602, while transmitting the buffer state and CSI. In step 604, the node B 602 performs scheduling in consideration of a radio resource state of a relevant cell and also the buffer state and CSI transmitted from the UE 601. In step 605, the node B 602 transmits the maximum allowed TFC and TTI determined according to the scheduling to the UE 601 through a control channel. In steps 606 and 607, the UE 601 and the node B 602 set a current TTI to be the determined TTI. In step 608, the UE 601 transmits EUDCH packet data to the node B 602 on the basis of the maximum allowed TFC and TTI.

FIG. 6B is a view illustrating a procedure for changing a TTI by a node B while a service is being provided according to an embodiment of the present invention. In step 611, a UE 609 transmits EUDCH data to a node B 610 in a set TTI. In step 612, the node B 610 performs scheduling periodically and determines if it is necessary to change a previously set TTI. When it is necessary to change the previously set TTI, the node B 610 performs scheduling in consideration of a radio resource state of a cell in which the UE 609 is located. In step 613, the node B 610 transmits maximum allowed TFC and TTI newly-changed through the scheduling to the UE 609 through a control channel. In steps 614 and 615, the UE 609 and the node B 610 set a current TTI to be the determined TTI. In step 616, the UE 609 transmits EUDCH packet data to the node B 610 according to the changed maximum allowed TFC and TTI.

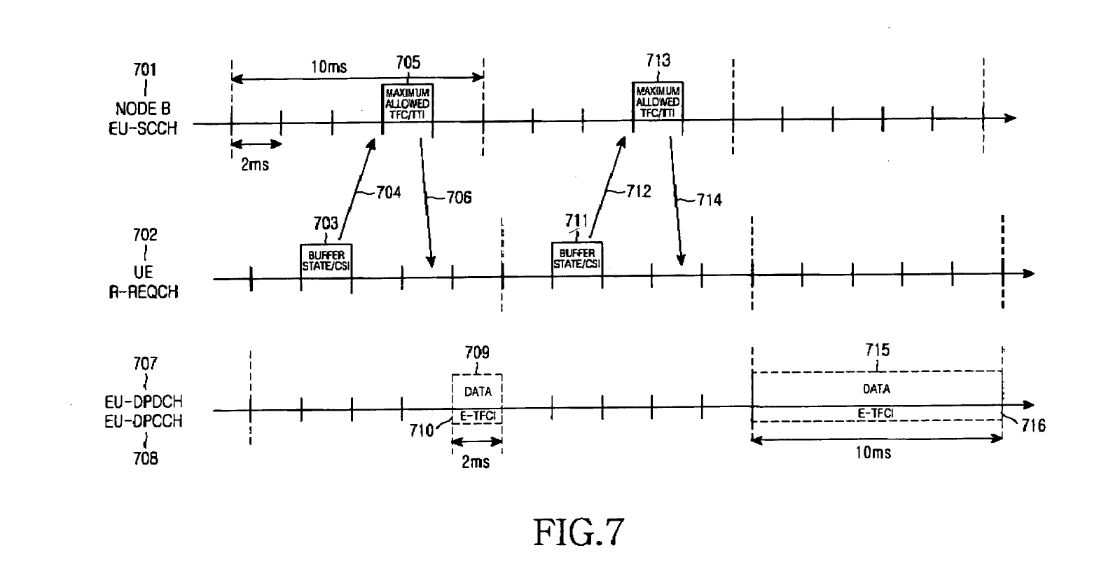

FIG. 7 is a view illustrating a procedure for controlling a TTI when an EUDCH service is set according to an embodiment of the present invention. In FIG. 7, node B 701 supports a short TTI of 2 ms and a long TTI of 10 ms to service an EUDCH. In step 704, in order to be assigned a radio resource required for data transmission through EUDCH, a UE inserts a buffer state and CSI 703 into an R-REQCH 702 and transmits the R-REQCH 702 to the node B 701. In step 705, the node B 701 having received the R-REQCH 702 determines maximum allowed TFC and TTI, which can be assigned to the UE using the buffer state and CSI 703.

For example, when the node B 701 checks the buffer state and CSI 703 transmitted from the UE and determines that the channel status of a cell in which the UE is located is inadequate, the node B 701 assigns a short TTI of 2 ms, such that the UE may transmit EUDCH data transported to the buffer while being adapted to the change of the channel status. However, when the node B 701 determines that the channel status has stabilized, the node B 701 assigns a long TTI of 10 ms to the UE. In this embodiment, a case in which a short TTI is first assigned and then a long TTI is assigned will be described.

In step 706, the node B 701 inserts the scheduled maximum allowed TFC and TTI for the UE into an EU-SCCH and transmits the EU-SCCH to the UE. In step 709, the UE, which is monitoring the EU-SCCH, confirms that control information of the EU-SCCH is transmitted to the UE, and then transmits EUDCH packet data according to the maximum allowed TFC and TTI determined by the node B 701. Herein, a TTI determined by the node B 701 is the TTI of 2 ms in step 705, and thus the UE transmits EUDCH data in the TTI of 2 ms through EU-DPDCH. At this time, the EUDCH also transmits an E-TFCI through an EU-DPCCH so that the node B 701 can demodulate EUDCH data transmitted through the EU-DPDCH.

After a transmission period elapses, when packet data to be transmitted through the EUDCH are transported to the buffer of the UE, the UE inserts information of representing the state of the buffer and CSI 711 into an R-REQCH 702 to transmit them to the node B 701 in step 712. That is, in step 712, the UE requests assignment of radio resources for transmitting packet data through the EUDCH. In step 714, the node B 701 checks the state of the buffer and CSI, which are included in the R-REQCH 702 transmitted from the UE, and assigns a maximum allowed TFC and the long TTI of 10 ms 713 to the UE.

The UE is assigned the long TTI of 10 ms and transmits EUDCH data in the TTI of 10 ms. In this case, in order to transmit data in synchronizing with other uplink channels, the UE transmits EUDCH data through an EU-DPDCH in a 10 ms unit as indicated by reference numeral 715, after having a delay until a boundary of a 10 ms section, instead of immediately transmitting the data. Also, the UE transmits an E-TFCI for demodulating the EUDCH data.

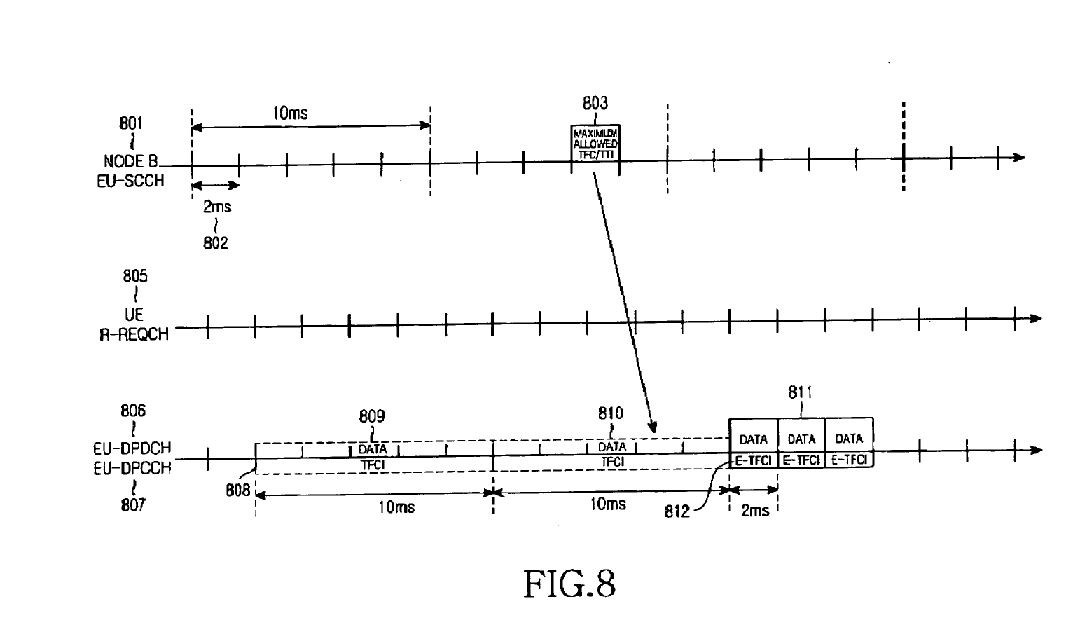

FIG. 8 is a view illustrating the procedure for changing a TTI while a service is being performed according to an embodiment of the present invention. In this embodiment, the case in which the TTI changes from the long TTI of 10 ms to the short TTI of 2 ms will be described.

Referring to FIG. 8, in steps 809 and 810, a UE is performing an EUDCH service according to the long TTI of 10 ms using a maximum allowed TFCI assigned from a node B 801. In such a state, the node B 801 checks the condition of a cell in which the UE is located through a periodic scheduling. As a result, it is determined that assigning the short TTI of 2 ms is better than assign the long TTI of 10 ms because the channel environment of the UE frequently changes, the node B 801 performs a change control to the short TTI of 2 ms through an EU-SCCH in step 804. That is, in step 804, the node B 801 transmits a maximum allowed TFC and a changed TTI 803 to the UE through the EU-SCCH.

While the UE is monitoring the EU-SCCH, the UE sends the changed TTI information to an EUDCH controller when receiving control information for the UE. The UE changes a currently set TTI into a different TTI and then transmits EUDCH data using the changed TTI. That is, the UE transmits packet data in the long TTI of 10 ms and then transmits packet data in the short TTI of 2 ms as indicated by reference numeral 811 from the following TTI.

Additionally, when the node B does not transmit a newly set TTI to the UE through the EU-SCCH, although the node B knows the newly set TTI, the node B receives packet data from the UE according to a previous TTI. In this case, in order to prevent a wrong operation resulting from a TTI set between the node B and the UE, the UE transmits TFCI information relating to the transport format of EUDCH data and flag information relating to the TTI information to the node B through an EU-DPCCH in the same time. That is, in order to notify the node B of TTI information of the UE itself according to the transmission of relevant packet data, for example, when the UE transmits packet data in the short TTI of 2 ms, the UE transmits the E-TFCI of the 2 ms TTI to the node B through the EU-DPCCH. In contrast, when the UE transmits packet data in the long TTI of 10 ms, although the node B does not receive an E-TFCI of the 10 ms TTI, the node B can recognize a relevant TTI of EUDCH data by sensing energy.

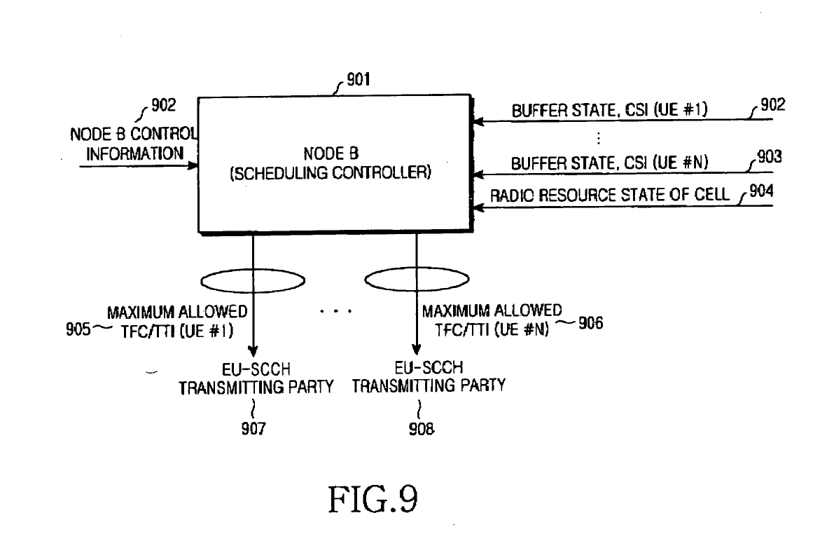

FIG. 9 is a view illustrating a scheduling controller in a node B according to an embodiment of the present invention. Referring to FIG. 9, a node B includes a scheduling controller 901 to perform scheduling. The scheduling controller 901 receives each buffer state and CSI as indicated by reference numeral 902 or 903 from each UE, which is located in a cell and performs scheduling in consideration of a radio resource state 904 of the relevant cell. The scheduling controller 901 performs scheduling when radio resource assignment is requested from a UE as described above or whenever a predetermined period of time elapses.

Through a scheduling procedure, the scheduling controller 901 determines a maximum allowed TFC and TTI 905 or 906 for each UE. The determined maximum allowed TFC and TTI 905 or 906 is inserted into control information for each relevant UE and is sent to an EU-SCCH transmission part 907 or 908, thereby being transmitted to each relevant UE. In this case, information relating to a TTI assigned to each UE can be expressed with one indication bit as shown in Table 1 below.

TABLE 1

| TTI Information | Indication Bit |
|---|---|
| TTI = 2 ms | 0 |
| TTI = 10 ms | 1 |

For example, when the short TTI is assigned to UE 1, the node B sets the bit of TTI information to be ‘zero’ and transmits the set bit. However, when the short TTI is assigned to UE N, the node B sets the bit of TTI information to be ‘one’ and transmits the set bit.

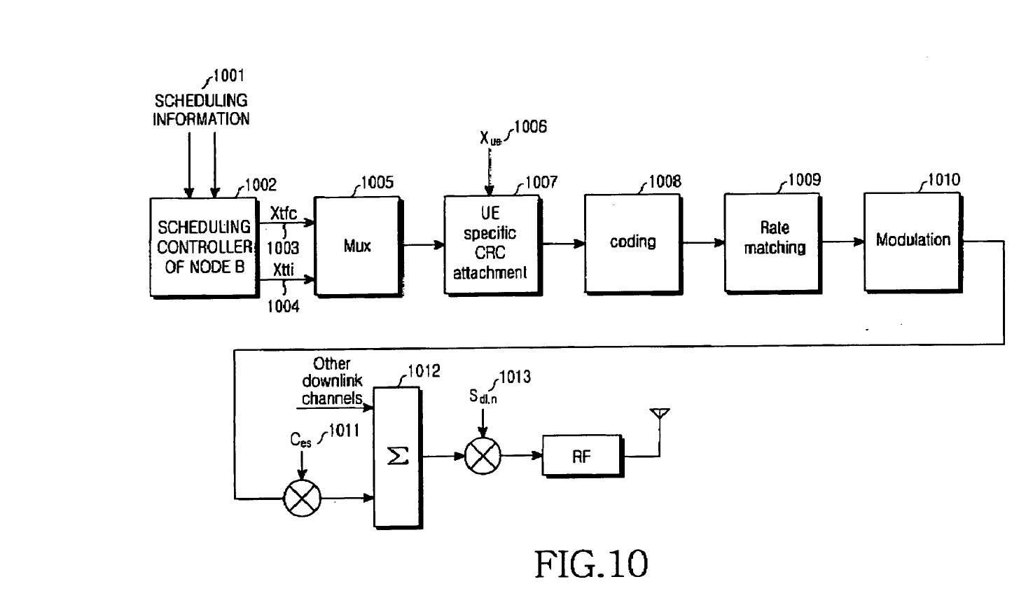

FIG. 10 is a block diagram illustrating a transmitter of a node B that transmits determined TTI information to a relevant UE according to an embodiment of the present invention. Referring to FIG. 10, a scheduling controller 1002 of a node B receives scheduling information 1001 corresponding to each of multiple UEs to perform scheduling and determines maximum allowed TFC information 1003 and TTI information 1004. The scheduling information 1001 includes information relating to a power that can be used for transmission in each UE, information relating to an amount of packet data to be transmitted which are stored in the buffer of a relevant UE, etc. It is possible to represent the maximum allowed TFC information 1003 and the TTI information 1004 in a bit unit, which may be expressed as shown in table 1 above.

A multiplexer 1005 receives the maximum allowed TFC information 1003 and the TTI information 1004, and performs a multiplexing operation with respect to the received information. That is, the maximum allowed TFC information 1003 and the TTI information 1004 assigned to each UE are multiplexed to be transmitted to each relevant UE through an EU-SCCH.

A CRC attachment unit 1007 attaches a UE-specific CRC for each UE to the maximum allowed TFC information 1003 and the TTI information 1004, such that each UE can identify the maximum allowed TFC information 1003 and the TTI information 1004 assigned to each UE itself through the EU-SCCH.

Additionally, a UE checks the UE-specific CRC. As a result, when there is no error, the UE determines that what to be received is control information for UE itself. However, when there is an error, the UE determines that what to be received is control information for another UE or wrong information.

The information in which a CRC is attached is coded into channel codes in a coding unit 1008 and then is rate-matched by a rate matching unit 1009 to be transmitted. The data-matched data is modulated by a modulator 1010, spread by a spreading unit 1011, and is output. The spread EU-SCCH is added to other downlink channels by an adder 1012, is scrambled by a scrambler 1013, and then transmitted through an RF unit to a radio area.

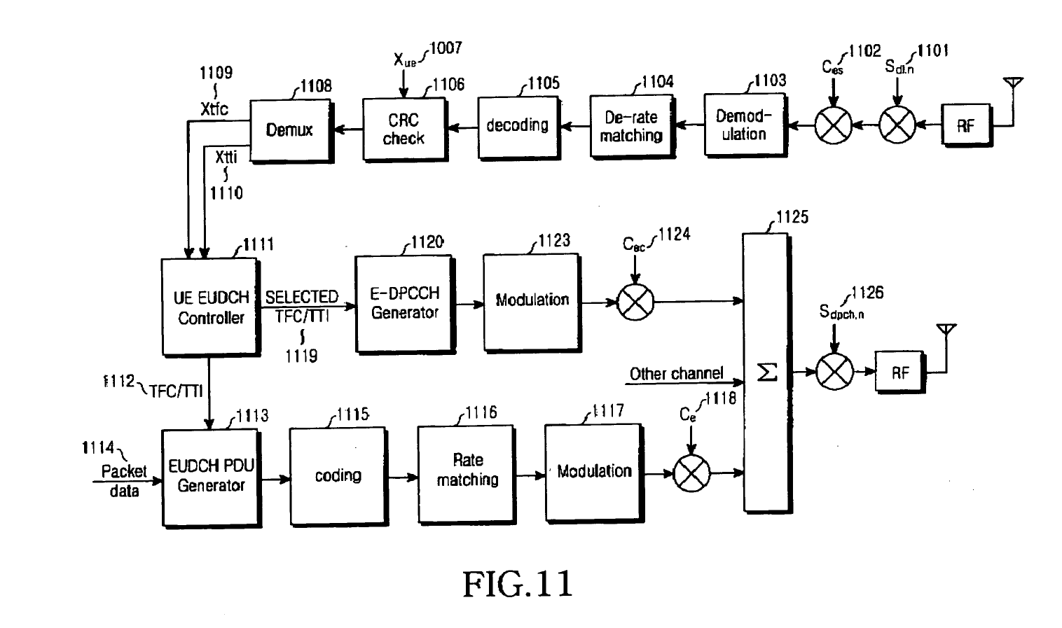

FIG. 11 is a block diagram illustrating a UE according to an embodiment of the present invention. Referring to FIG. 11, a UE changes an EU-SCCH, which includes a maximum allowed TFCI and TTI and is transmitted from a node B through an RF unit, into a baseband signal, and then transmits the changed signal to a descrambler 1101. The descrambler 1101 descrambles the transmitted signal by multiplying the transmitted signal by a descrambling code. The descrambled signal is despread by a despreading unit 1102 and then is transmitted to a demultiplexer 1103. The demultiplexer 1103 demultiplexes multiplexed information, a de-rate matching unit 1104 performs a rate matching operation, and then a decoder 1105 decodes coded data.

A CRC detector 1106 performs a CRC checking operation using a UE-specific CRC 1107 particularly established to each UE in order to determine if the control information is information for the UE itself. Because the transmitter of the node B illustrated in FIG. 10 transmits the control information with the US-specific CRC attached, the CRC detector 1106 determines that the control information corresponds to itself when checked CRC is identical to the own UE-specific CRC.

A demultiplexer 1108 separates information having undergone the CRC detection operation into TFCI information 1109 and TTI information 1110 and transmits the separated information to an EUDCH controller 1111. The EUDCH controller 1111 selects TFC to be transmitted through an EUDCH on the basis of provided maximum allowed TFC and TTI. The selected TFC is transmitted to an EUDCH PDU generator 1113 of a MAC layer, and data packet 1114 for transmission is generated as an EUDCH PDU in the MAC layer to be transmitted a coder 1115.

EUDCH data 1114 for transmission is coded by the coder 1115 and then is rate-matched by a rate matching unit 1116. The rate-matched data is modulated by a modulator 1117 and then spread by a spreading unit 1118. The spread data is added by an adder 1125, is scrambled by a scrambler 126, and is transmitted to a radio area. An EUDCH controller transmits TFC information and TTI 1119, which are selected for the node B to demodulate the EUDCH packet data, to an EU-DPCCH generator 1120. A generated DU-DPCCH is also modulated by a modulator 1123, spread by a spreading unit 1124, and is added to the EUDCH data 1114 by an adder 1125. Signals output from the adder 1125 are scrambled by a scrambler 1126 and then are transmitted to the radio area.

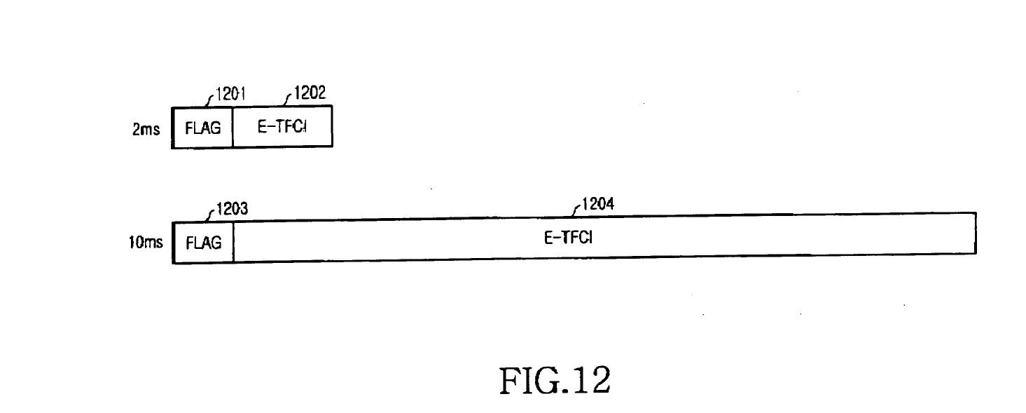

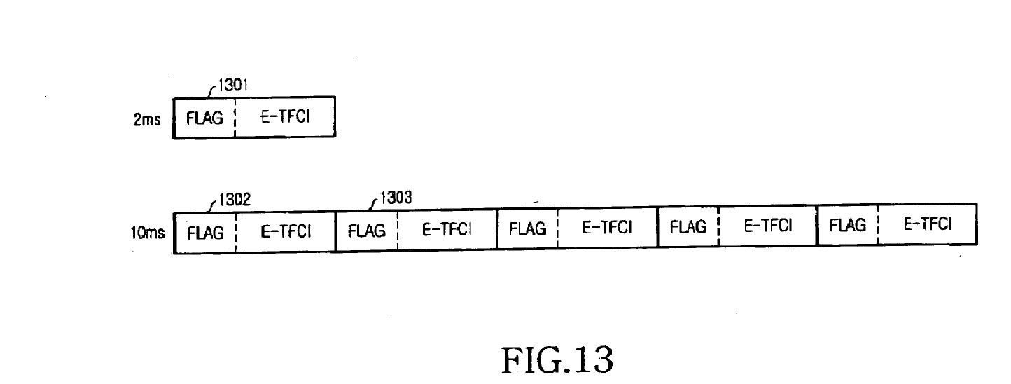

FIGS. 12 and 13 illustrate frame structures for transmitting flag information. Herein, the flag information notifies a node B of changed TTI information according to the present invention. A UE notifies the node B of changed TTI information using the flag information.

FIG. 12 illustrates a frame structure for separately transmitting flag information and an E-TFCI according to an embodiment of the present invention. A UE time-multiplexes E-TFCI information and flag information, which are used to transmit EUDCH packet data, and transmits the time-multiplexed information. That is, using the 2 ms TTI, the UE time-multiplexes flag information 1201 and E-TFCI information 1202 to make up a frame having a time period of 2 ms, and assigns the made-up frame to a predetermined physical channel. Also, using the 10 ms TTI, the UE time-multiplexes flag information 1203 and E-TFCI information 1204 to make up a frame having a time period of 10 ms, and assigns the made-up frame to a separate physical channel other than the physical channel to which the 2 ms TTI is assigned.

In this case, a UE-specific CRC is attached to the E-TFCI information 1204, thereby notifying the node B that relevant information is transmitted from the UE. However, the flag information may be transmitted without an attached CRC and/or a separate coding process. Also, the flag information must have a constant length regardless of the time period of the TTI. Therefore, the node B senses the flag information in every set of TTIs, that is, every 10 ms when the TTI is set to be 10 ms, thereby checking the TTI used for the UE to transmit EUDCH packet data.

FIG. 13 is a view illustrating a frame structure for simultaneously processing and transmitting flag information and an E-TFCI according to an embodiment of the present invention. Referring to FIG. 12, when a UE uses the 2 ms TTI, the UE makes up a frame 1301 having a time period of 2 ms by combining flag information and E-TFCI information. Also, when a UE uses the 10 ms TTI, the UE makes up a frame (which is not shown) having a time period of 10 ms by combining flag information and E-TFCI information. In these cases, the UE inserts a CRC into the flag information and E-TFCI information, codes the CRC-inserted information, and transmits the coded information, thereby improving the reliability to the flag information.

For example, when the UE uses the 10 ms TTI, the node B cannot determine whether a currently-used TTI is the 2 ms TTI or the 10 ms TTI until the TTI of 10 ms elapses, that is, until the node B has received the entire E-TFCI during a previous 10 ms TTI.

In this case, it is possible to transmit an E-TFCH of a 2 ms TTI one time within the 10 ms TTI as indicated by reference numeral 1303 in order to reduce interference caused by a different uplink, and it is possible to repeatedly transmit an E-TFCH of a 2 ms TTI five times as indicated by reference numeral 1303 by reducing a transmission power.

As described above, according to the embodiment described with reference to FIG. 13, when a TTI set to be a certain value is used, E-TFCI information having TTIs set to be various values can be transmitted, thereby improving the EUDCH service efficiency of the UE.

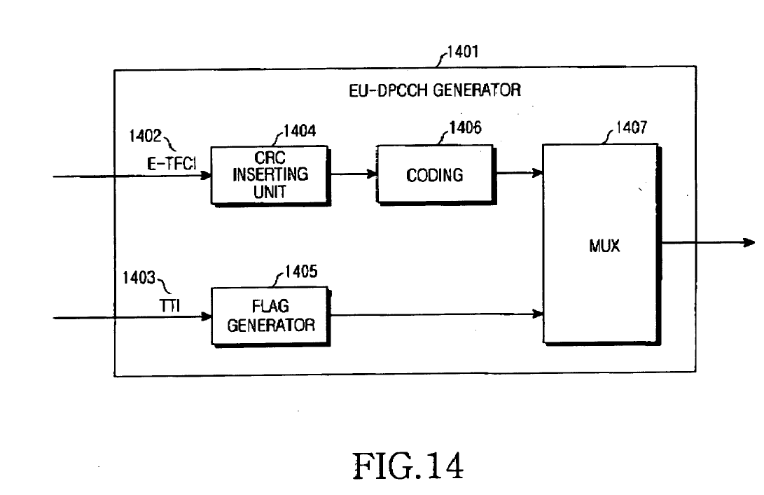

FIG. 14 is a block diagram illustrating an E-DPCCH generator when flag information and E-TFCI information are separately transmitted according to an embodiment of the present invention. That is, FIG. 14 illustrates an E-DPCCH generator to separately time-multiplex and transmit the flag information and E-TFCI.

Referring to FIG. 14, an EU-DPCCH generator 1401 transmits E-TFCI information 1402 including selected TFC information to a CRC inserting unit 1404 to insert a UE-specific CRC into the E-TFCI information. The CRC-inserted E-TFCI information is coded by a coder 1406 and then is transmitted to a multiplexer 1407. Also, TTI information is input to a flag generator 1405, such that flag information is generated. The flag information and E-TFCI information are time-multiplexed in the 2 ms TTI or the 10 ms TTI as described with reference to FIG. 12 and are transmitted to a node B through an EU-DPCCH.

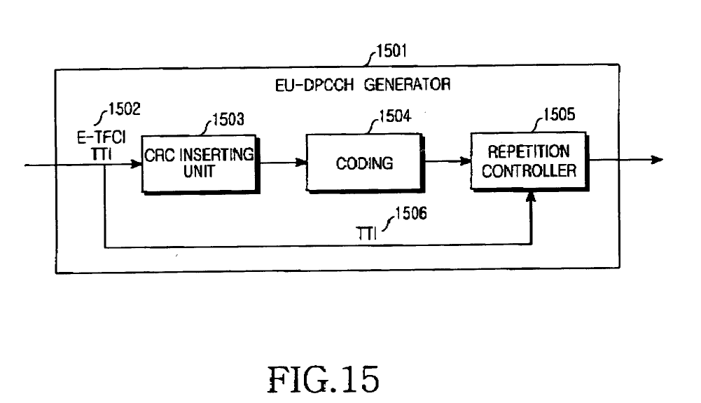

FIG. 15 is a block diagram illustrating an E-DPCCH generator when flag information and E-TFCI information are simultaneously processed and transmitted according to an embodiment of the present invention. Referring to FIG. 15, a CRC inserting unit 1503 receives flag information and E-TFCI information, and inserts a UE specific CRC into the received information. The CRC-inserted information is channel-coded by a coder 1504 and is output. Additionally, the E-DPCCH generator repeatedly outputs a frame constructed in a 2 ms unit through a repetition controller 1505 even when a relevant TTI is set to be 10 ms. That is, the repetition controller 1505 receives TTI information and repeatedly outputs an E-TFCI having the 2 ms unit five times.

As described above, according to embodiments of the present invention, a node B variably controls a TTI in consideration of a resource environment of a cell, a buffer state of each UE, and channel status information of each UE when the node B providing an enhanced uplink channel service, thereby efficiently scheduling radio resources.

While the present invention has been shown and described with reference to certain preferred embodiments thereof, it will be understood by those skilled in the art that various changes in form and details may be made therein without departing from the spirit and scope of the present invention as defined by the appended claims.

1. A method for variably controlling a transmission time interval for packet data of a User Equipment (UE) in a mobile communication system, the method comprising the steps of:
transmitting, from the UE to a node B, information relating to an amount of packet data to be transmitted through an uplink and information relating to a channel status of the UE;
setting, by the node B, a transmission time interval for transmitting the packet data for each of a plurality of UEs including the UE, based on the information relating to the amount of the packet data transmitted through the uplink and the information relating to the channel status of the UE;
inserting the set transmission time interval into a downlink control channel; and
transmitting the downlink control channel according to the plurality of UEs.

2. The method as claimed in claim 1, further comprising the step of:
inserting, by the node B, a data rate, which is set based on the information relating to the amount of the packet data transmitted through the uplink and the information relating to the channel status of the UE, into the downlink control channel.

3. The method as claimed in claim 1, further comprising a step of setting at least one of the transmission time interval and the data rate by the node B in consideration of a radio resource of a cell in which the UE is located.

4. A method for controlling a transmission time interval by a node B in an asynchronous wideband code division multiple access (W-CDMA) mobile communication system that services an enhanced uplink dedicated transport channel, the method comprising the steps of:
transmitting, from User Equipment (UE) to the node B, information indicating a state of a buffer in which data to be transmitted through an uplink is stored and information of representing a channel status of the UE, when the UE sets an uplink service;
determining a transmission time interval and a transport format combination indicator for indicating a radio resource to be assignable by the node B based on the information of representing the state of the buffer and the information of representing the channel status of the UE; and
transmitting the determined transport format combination indicator and transmission time interval to the UE through a control channel.

5. The method as claimed in claim 4, further comprising the steps of:
receiving the control channel in the UE;
transmitting packet data through an uplink data channel by the UE according to the transport format combination indicator and the transmission time interval; and
transmitting information relating to a transmission time interval used in the UE through an uplink control channel from the UE to the node B.

6. The method as claimed in claim 5, wherein the information relating to the transmission time interval used in the UE is set using a 1-bit indicator.

7. A method for variably controlling a transmission time interval for packet data of a User Equipment (UE) by a node B in an asynchronous wideband code division multiple access (W-CDMA) mobile communication system that services an enhanced uplink dedicated transport channel, the method comprising the steps of:
determining a transmission time interval for the UE to transmit the packet data through an uplink by the node B according to a set time period in consideration of a channel status of a cell in which the UE is located;
transmitting the packet data through the uplink data channel according to the determined transmission time interval by the UE; and
transmitting, from the UE to the node B, information relating to the transmission time interval used in the UE, through an uplink control channel.

8. A node B system for variably controlling a transmission time interval for packet data of a User Equipment (UE) in a mobile communication system, the system comprising:
a receiver for receiving information relating to an amount of the packet data to be transmitted from the UE through an uplink and information relating to a channel status of the UE; and
a scheduling controller for setting a transmission time interval and a maximum allowed transport format combination information, which are assignable, based on the information relating to the amount of the packet data and the information relating to the channel status.

9. The system as claimed in claim 8, further comprising a transmission unit for transmitting the maximum allowed transport format combination information and the transmission time interval to the UE through a control channel.

10. A system for enabling a node B to variably control a transmission time interval for packet data of a User Equipment (UE) in an asynchronous wideband code division multiple access (W-CDMA) mobile communication system that services an enhanced uplink dedicated transport channel, the system comprising:
a scheduling controller for receiving information relating to an amount of the packet data to be transmitted through an uplink from a plurality of UEs, determining a maximum allowed transport format combination indicator and transmission time interval information for each of the plurality of UEs, and representing each determined indicator and each determined information in a bit unit; and
an inserting unit for inserting specific error detection information for each of the plurality of UEs into the maximum allowed transport format combination indicators and the transmission time interval information, thereby enabling each of the plurality of UEs to differentiate the maximum allowed transport format combination indicators and the transmission time interval information.

11. A User Equipment (UE) system for transmitting packet data to a node B in an asynchronous wideband code division multiple access (W-CDMA) mobile communication system that services an enhanced uplink dedicated transport channel, the system comprising:
a detector for receiving control information from the node B and performing an error detection operation using specific error detection information for the UE in order to determine if the control information is for the UE; and
an uplink controller for determining a transport format combination for the packet data to be transmitted through an uplink, using a maximum allowed transport format combination indicator and transmission time interval information transmitted from the detector.

12. The system as claimed in claim 11, further comprising an uplink generator including an inserting unit for receiving the transport format combination information from the uplink controller and inserting the specific error detection information for the UE into the received information, and a flag generator for receiving the transmission time interval information and generating information for notifying a transmission time interval information of the UE to the node B.

13. The system as claimed in claim 12, wherein the inserting unit inserts the specific error detection information for the UE into the transport format combination information and the transmission time interval information.

14. The system as claimed in claim 12, wherein the uplink generator further comprises a repetition controller for repeatedly outputting a transmission time interval to be used by the UE according to the transmission time interval determined by the node B.

15. A method for transmitting packet data from a User Equipment (UE) to a node B in an asynchronous wideband code division multiple access (W-CDMA) mobile communication system that services an enhanced uplink dedicated transport channel, the method comprising the steps of:
transmitting buffer state information and channel status information from the UE to the node B;
receiving transmission time interval information and scheduling assignment information determined according to the buffer state information and the channel status information from the node B;
generating transport format combination information for the packet data to be transmitted to the node B using the scheduling assignment information and the transmission time interval information;
generating flag information for indicating the transmission time interval information; and
transmitting the generated transport format combination information and flag information to the node B.

16. A method for transmitting over an enhanced uplink dedicated transport channel (EUDCH) when a plurality of transmission time intervals are supported in an asynchronous wideband code division multiple access (W-CDMA) mobile communication system that services the EUDCH, the method comprising the steps of:
receiving, by a User Equipment (UE), control information for transmission over the E-DCH from a node B;
determining a transport format combination for packet data using the control information;
generating control information data from the EUDCH and uplink control information for the EUDCH including the transport format combination, such that the control information data can be transmitted in accordance with a first transmission time interval, which is a minimum transmission time interval;
transmitting the generated control information data in accordance with a transmission time interval when the transmission time interval equals the first transmission time interval; and
repeatedly transmitting the generated control information data N times in accordance with a second transmission time interval when the transmission time interval equals the second transmission time interval, which is N times larger than the first transmission time interval, where N is natural number.

17. The method as claimed in claim 16, wherein the first transmission time interval is 2 ms.

18. The method as claimed in claim 16, wherein the second transmission time interval is 10 ms.

19. The method as claimed in claim 16, wherein the control information includes a new data indictor (NDI) indicating if retransmission is performed according to support of a hybrid automatic retransmission request (H-ARQ), in addition to the transport format combination.

20. The method as claimed in claim 16, wherein the control information includes a redundancy version (RV) for supporting a hybrid automatic retransmission request (H-ARQ), in addition to the transport format combination.

21. The method as claimed in claim 16, wherein the control information includes a quality of service (QoS) information, in addition to the transport format combination.
